(19) United States
(12) Patent Application Publication
(10) Pub. No.: US 2010/0262051 A1
(43) Pub. Date: Oct. 14, 2010

(54) MASSAGE AND COSMETIC PRODUCT DISPENSING ASSEMBLY

(75) Inventor: Vincent DE LAFORCADE, Rambouillet (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: L'OREAL, Paris (FR)

(21) Appl. No.: 12/757,599

(22) Filed: Apr. 9, 2010

Related U.S. Application Data
(60) Provisional application No. 61/220,766, filed on Jun. 26, 2009.

(30) Foreign Application Priority Data
Apr. 9, 2009 (FR) 0952342

(51) Int. Cl. A61H 7/00; A45D 40/00

(52) U.S. Cl. 601/84; 132/320

(57) ABSTRACT

A massage and cosmetic product dispensing assembly includes a cosmetic product storage container, a member for dispensing the cosmetic product stored in the container, a massage and cosmetic product application device. The massage and application device includes a fixed support which is fixed relative to the container, peripheral massage members connected to the fixed support, a central support which is movable relative to the fixed support and suitable for actuating the dispensing member, and central massage members connected to the movable central support.

### CROSS REFERENCE

This application claims the benefit of priority under 35 U.S.C. §120 for U.S. Provisional No. 61/220766, filed Jun. 26, 2009, and claims the benefit of priority under 35 U.S.C. §119 from French Application No. 09 52342, filed Apr. 9, 2009, the entire contents of each which are incorporated herein by reference.

### BACKGROUND OF THE INVENTION

1. Field of the Invention

The invention relates in general to massage assemblies, in particular for the scalp.

More specifically, a first aspect of the invention relates to a massage and cosmetic product dispensing assembly of the type comprising:
a cosmetic product storage container;
a member for dispensing the cosmetic product stored in the container;
a massage and cosmetic product application device.

2. Discussion of Background

A “cosmetic product” is understood in this case to refer in particular to a product as defined in Council Directive 93/35EC of 14 Jun. 1993.

An assembly of this type is known from WO-03/070312. In this assembly, the massage device is mounted on the projecting shaft of the cosmetic product dispensing member. To massage the scalp, the user has to apply the massage device to his head, without applying excessive pressure to the device. To apply the cosmetic product, the user presses harder in such a way as to depress the projecting shaft of the dispensing member.

In an assembly of this type, it is difficult to control the application pressure of the massage device to the head in an appropriate manner. It is therefore difficult to massage the head without dispensing the cosmetic product, since the massage assembly does not always do what the user would like it to do.

### SUMMARY OF THE INVENTION

Within this context, the object of the invention is to propose a massage and cosmetic product dispensing assembly which is easier to use.

For this purpose, the invention relates to a massage and dispensing device of the aforementioned type, characterised in that the massage and application device comprises:
a fixed support which is fixed relative to the container;
peripheral massage members connected to the fixed support;
a central support which is movable relative to the fixed support and suitable for actuating the dispensing member;
central massage members connected to the movable central support.

The fixed support may be connected to the container directly or indirectly, in particular via a fixing retainer on the neck of the container. The movable support may be connected directly or indirectly to the dispensing member in order to actuate it.

The invention may further exhibit one or more of the following features, taken individually or in any technically feasible combination:
the massage and application device is moulded in one piece;
at least some peripheral or central massage members comprise a lower part made of a first plastics material and a distal part made of a second plastics material different from the first, intended to come into contact with the user's scalp, preferably the second plastics material being more flexible than the first;
the movable support is connected to the fixed support via a deformable material web;
the peripheral massage members are deformable between at least one first massage position and at least one second actuation position of said dispensing member via said central support;
the peripheral massage members are deformable upon engagement with a region to be treated, in particular the scalp;
the cosmetic product dispensing member comprises an actuation shaft provided with an internal channel for the cosmetic product to pass through, the actuation shaft being movable between an inactive position, in which the cosmetic product does not pass through the through-channel, and an active position controlling the passage of the cosmetic product through the through-channel, the movable support being connected to the actuation shaft;
the movable support comprises a central cone for receiving a distal end of the actuation shaft, said cone being provided with an aperture for releasing the cosmetic product, positioned in the extension of the through-channel of the actuation shaft;
the movable support comprises an aperture for releasing the cosmetic product, and the central massage members are arranged in a first circle centred on the release aperture;
the movable support comprises an aperture for releasing the cosmetic product, and the peripheral massage members are arranged around the central massage members in a second circle centred on the release aperture;
the central and peripheral massage members are projections extending substantially parallel to the actuation shaft;
the peripheral massage members are movable relative to the fixed support in each case between a rest position, in which said peripheral massage member projects at a first height relative to the fixed support parallel to the actuation shaft, and a retracted position, in which said peripheral massage member projects at a second height relative to the fixed support parallel to the actuation shaft, the second height being less than the first;
the peripheral massage members and the fixed support are shaped in such a way that at least one peripheral massage member abuts against the fixed support when said peripheral massage member reaches the retracted position thereof;
the peripheral massage members are connected to the fixed support via deformable tabs;
when the actuation shaft is in the inactive position thereof, the peripheral massage members project relative to the fixed support parallel to the actuation shaft at a greater height than the central massage members.

A second aspect of the invention relates to a massage and cosmetic product application device, the device comprising:
a fixed support provided to be connected rigidly to a container for storing the cosmetic product;
peripheral massage members connected to the fixed support;
a movable central support, provided to be connected to a member for dispensing the cosmetic product stored in the container, and movable relative to the fixed support;
central massage members connected to the movable central support.

As should be apparent, the invention can provide a number of advantageous features and benefits. It is to be understood that, in practicing the invention, an embodiment can be constructed to include one or more features or benefits of embodiments disclosed herein, but not others. Accordingly, it is to be understood that the preferred embodiments discussed herein are provided as examples and are not to be construed as limiting, particular since embodiments can be formed to practice the invention that do not include each of the features of the disclosed examples.

### BRIEF DESCRIPTION OF THE DRAWINGS

A better understanding of the invention will be gained from reading the following description in conjunction with the accompanying figures. The figures are offered purely as a guide and by way of example, and in no way limit the invention.

Further features and advantages of the invention will become clear from the following detailed description, given by way of illustration and in a non-limiting manner with reference to the appended drawings, in which:

FIG. 1 is a perspective view of a massage and cosmetic product dispensing assembly according to the invention;

FIG. 2 is a perspective view of the massage and application device of the assembly of FIG. 1;

FIG. 3 is a view of the massage and application device of FIG. 2 from above;

FIG. 4 is a view of the massage and application device of FIG. 2 from below;

FIG. 5 is a perspective view of the massage and application device, part of this device being cut away to allow particular parts of the device to be seen;

FIG. 6 is a side view of the assembly of FIG. 1, in a situation where this assembly is being used to massage a user's scalp;

FIG. 7 is a view similar to that of FIG. 6 in a situation where the user wishes to release the cosmetic product onto the scalp;

FIG. 8 is an enlarged view of the release aperture of the massage and application device, in a variant in which a discharging means is arranged at the output of the aperture, the central massage members not being shown; and

FIG. 9 is a sectional view of the aperture in the dispensing member from FIG. 8, viewed in the direction of the arrows IX of FIG. 8.

### DETAILED DESCRIPTION OF THE PREFERRED EMBODIMENTS

Referring now to the drawings, like reference numerals are utilized to designate identical or corresponding parts throughout the several views.

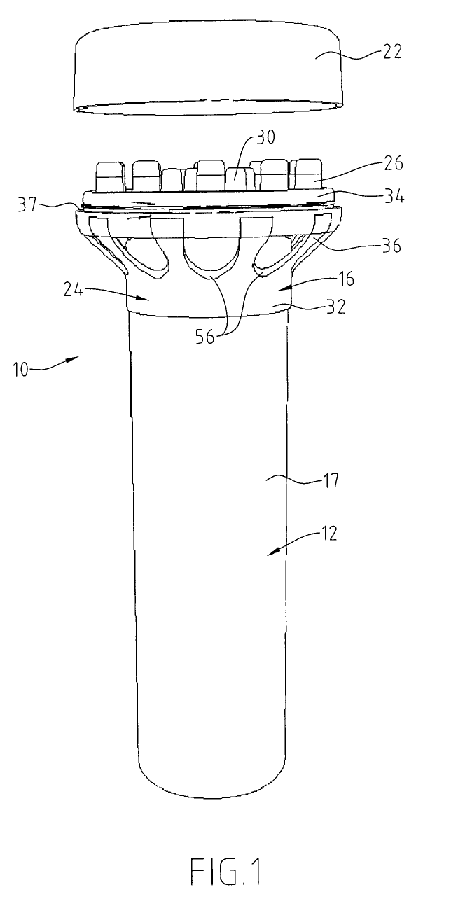

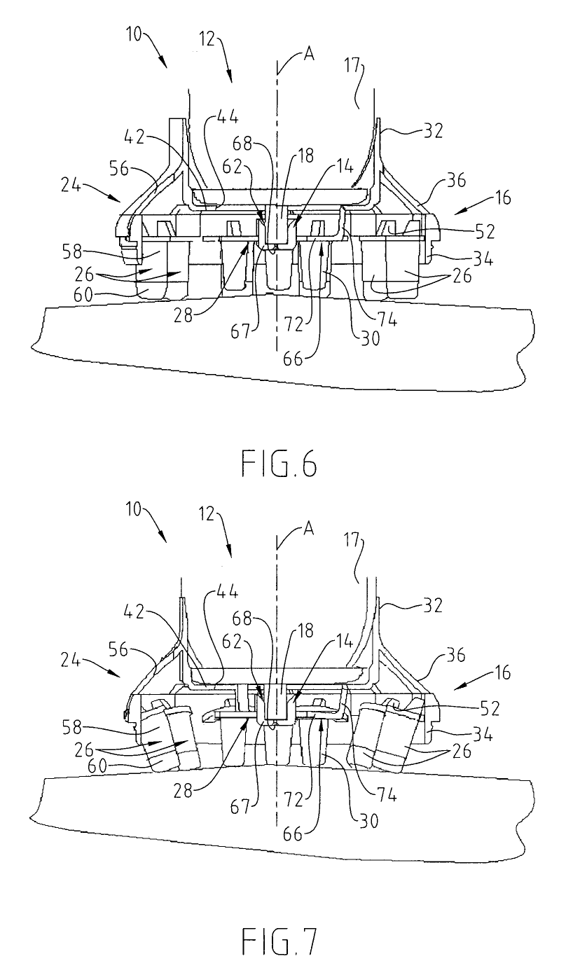

FIGS. 1 to 7 show an assembly 10 for massaging a cutaneous surface, in particular the scalp, and for applying a cosmetic product to this cutaneous surface. The assembly comprises a container 12 containing the cosmetic product, a member 14 (FIG. 6) for dispensing the cosmetic product stored in the container, and a massage and cosmetic product application device 16.

The device 16 may be used before or after depositing the cosmetic product on the cutaneous surface to massage and relax this surface, or simultaneously with the deposition of the cosmetic product on the cutaneous surface.

In the embodiment shown, which is no way limiting, the container 12 comprises a body 17 of an elongate cylindrical shape, having a longitudinal axis A and supporting on the upper end thereof a neck (not shown), this neck defining an opening for filling the container with cosmetic product. The longitudinal axis A of the container passes substantially centrally through the opening of the container.

The dispensing member 14, for example of the pump or valve type, is mounted on the neck of the container 12. This member 14 may comprise an actuation shaft 18 (FIG. 6) having an internal longitudinal channel of which one end is connected to the device 16 to supply said device with cosmetic product, and of which another end opens into the interior of the container 12. The neck of the container 12 may have a thread for cooperating with a corresponding thread in a ring of the member 14 to fix said member to the container. In a variant, the dispensing member 16 may be mounted on the neck of the container 12 by an interference fit, a snap fit, crimping or expansion.

A protective cap 22 (FIG. 1) may optionally be removably fixed to the container during the transport or storage thereof to protect the massage and application device 16, in particular from dust. This cap 22 is for example of a cylindrical shape and extends around the device 16 along the axis A.

In a known manner, when the cosmetic product is under pressure inside the container 12, the dispensing member 14 may be provided with a valve which is actuated by pressing on the upper end of the actuation shaft 18 in a direction substantially parallel to the axis A to make the cosmetic product pass through the internal channel. When the product is not under pressure in the reservoir 12, the dispensing member 14 may comprise a pump which is likewise actuated by pressing on the upper end of the shaft 18 in a direction parallel to the axis A to make the product pass through the internal channel.

The massage and application device 16 according to the invention advantageously comprises a central part forming a push button for actuating the pump or valve of the dispensing system, as will be described in greater detail below. In a variant, the cosmetic product can be made to flow within the internal channel of the dispensing member 14 from the container to the massage device 16 under gravity, simply by turning the device upside-down. When the container is compressible, pressing on the body of the container by hand can force the product to pass through the channel of the dispensing member 14.

The cosmetic product may be a care or treatment product, such as a capillary treatment lotion (hair loss prevention, antidandruff, shampoo, conditioner), a capillary colouring lotion, a styling lotion (gel, hairspray), a massage lotion (anticellulite, slimming, massage oil, moisturiser), etc.

The massage and application device 16 comprises:
a fixed support 24 connected to the container 12 and fixed relative to said container 12;
peripheral massage members 26, connected to the fixed support 24;
a movable central support 28 connected to the dispensing member 14 and movable relative to the fixed support 24;
central massage members 30 connected to the movable central support 28.

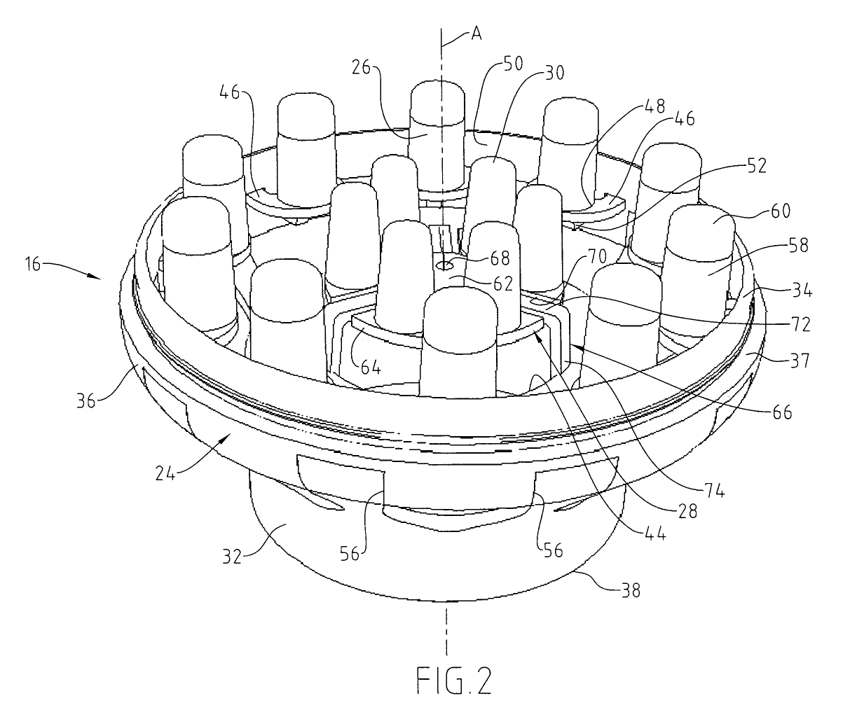

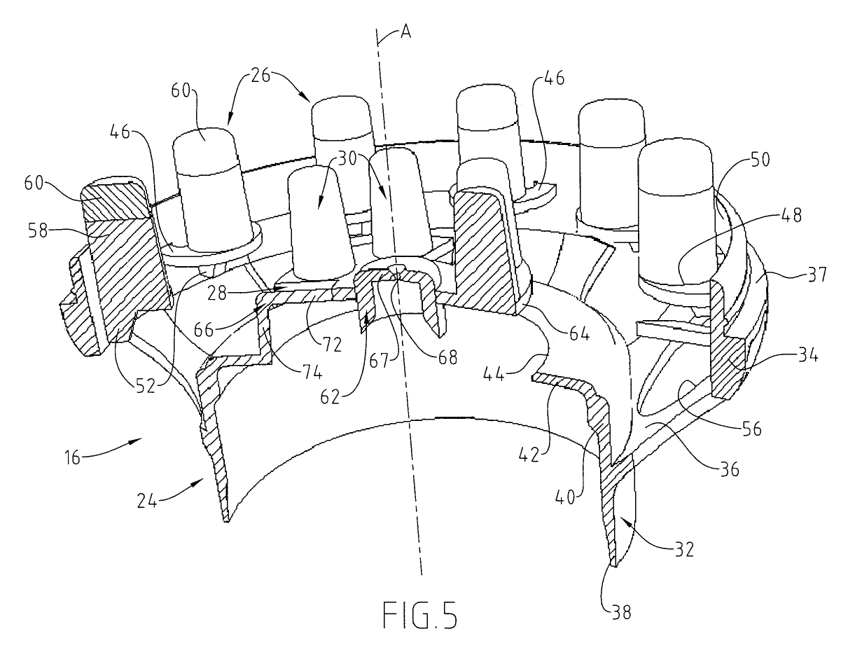

The fixed support 24, as can be seen in FIGS. 2 and 5, comprises a substantially cylindrical central band 32, a peripheral upper collar 34, and a substantially frustum-shaped connecting part 36 connecting the band 32 to the collar 34. The central axis of the band 32 is the longitudinal axis A. The band 32 is open at a lower axial end 38 and is partially closed at the opposite axial end 40 (FIG. 5). The axial end 38 is force-fitted over one end of the body 17 of the cosmetic product container. The upper end 40 is partially closed by an annular wall 42. The wall 42 is perpendicular to the axis A and has a substantially circular central opening 44.

The collar 34 is substantially cylindrical and also has a central axis coincident with the longitudinal axis A. It is axially offset from the container 12 relative to the band 32. It comprises a bearing surface 37 for receiving a peripheral edge of the cap 22.

The connecting part 36 bells out from the band 32 towards the collar 34. The lower part thereof is integral with the band 32. The upper thereof is integral with the collar 34.

The peripheral massage members 26 are projections pointing parallel to the longitudinal axis A. Each peripheral projection 26 is connected to the collar 34 by two flexible and deformable tabs 46. The tabs 46 connect the base 48 of each of the projections 26 to the radially internal face 50 of the collar. The face 50 is cylindrical and faces towards the central axis A.

The two tabs 46 are attached to substantially diametrically opposite regions of the corresponding projection 26. Each tab is connected to the internal face 50 of the collar by a substantially radial orientation part.

Each projection 26 is substantially cylindrical or frustum-shaped.

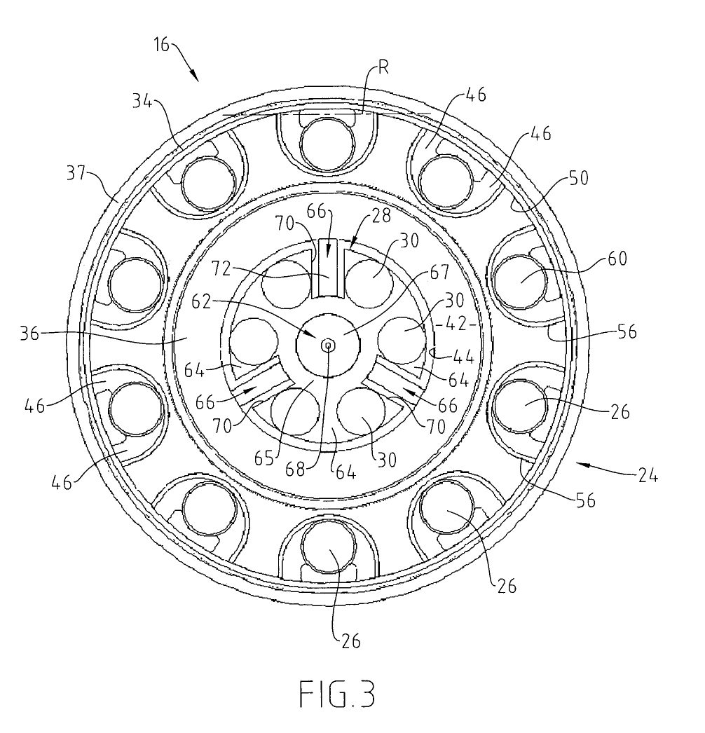

Each of the projections 26 is movable relative to the fixed support 24 between a rest position, shown in FIGS. 2, 5 and 6, and a retracted position, shown in FIG. 7. The projection 26 is normally resiliently returned to the rest position thereof, in which it is oriented substantially parallel to the longitudinal axis A. It can be moved by deformation of the tabs 46 into the retracted position thereof. The movement of the projection 26 between the rest position and the retracted position thereof corresponds to a rotation of the projection about an axis R shown in FIG. 3. The axis R passes through the connection points of the two tabs 46 to the collar 34. This axis is perpendicular to the longitudinal axis A, and is substantially tangential to the internal face 50 of the collar. During the displacement thereof from the rest position to the retracted position thereof, the projection is inclined radially towards the longitudinal axis A and axially towards the container 12.

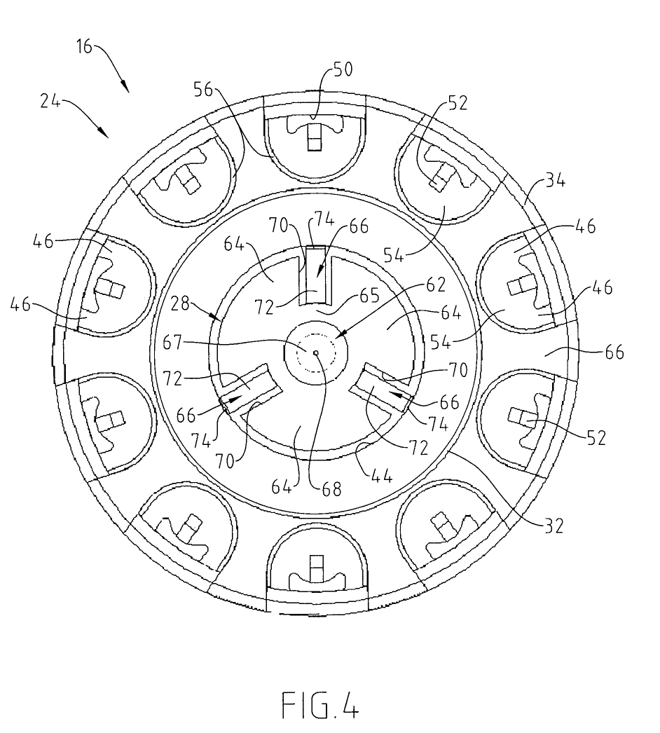

As is shown in FIG. 4, each projection 26 comprises a stop 52 positioned beneath said projection 26, i.e. on a lower face of the projection 54 facing towards the container. The stop 52 delimits the path of the projection 26 about the axis of rotation R when it passes from the rest position to the retracted position thereof. The stop 52 comes to bear against the internal face 50 of the collar when the projection reaches the retracted position thereof.

In the rest position thereof, the projection 26 projects relative to the collar 34 substantially parallel to the actuation shaft 18 at a first height. In the retracted position thereof, the projection 26 projects relative to the collar 34 at a second height lower than the first.

Openings 56 are formed in the connecting part 36, axially aligned with each of the projections 26. As viewed parallel to the longitudinal axis A, the recess of the opening 56 covers both the projection 26 and the two flexible tabs 46 associated therewith, as can be seen in FIGS. 3 and 4. It is thus possible to produce the projection 26 and the tabs 46 by moulding in one mould without a movable slide.

The peripheral projections 26 may be of a single material, i.e. formed of a single plastics material. In a variant, as shown in FIGS. 2 and 5, the projections 26 may comprise a lower part 58 of a first plastics material, and a distal part 60 of a second plastics material which is more flexible than the first. The lower part 58 is connected to the tabs 46. The distal part 60 is to come into contact with the user's scalp. The distal part 60 is for example formed of an EPDM, a Santoprene, an LDPE, a thermoplastic elastomer or even a silicone. The lower part 58 is for example made of polypropylene. Conversely, the distal part 60 may be made of a harder plastics material than the lower part.

The use of a thermoplastic elastomer high in plasticiser makes it possible to make the distal parts 60 slightly adhesive towards the scalp, in such a way that a lateral movement of the massage device will cause the scalp to move. This may be beneficial in terms of the sensation and the local blood microcirculation.

The central support 28 is a plate of a generally circular shape. As is shown in FIG. 5, it comprises a central cone 62 for receiving a distal end of the actuation shaft 18, three sectors 64 for supporting the central massage elements 30 (FIG. 3) and an annular region 65 fixing the sectors 64 to the central cone 62. Moreover, the central support 28 is connected to the fixed support 24 by three webs of deformable material 66.

The central cone 62 is located on the longitudinal axis A. It is coaxial with this axis A. Internally, it defines a blind recess in which the actuation shaft 18 engages. The central cone 62 is open towards the container 12 and closed at the other end by a wall 67 substantially perpendicular to the axis A. The wall 67 is pierced by an aperture 68 for releasing the cosmetic product. The aperture 68 is positioned in the extension of the internal channel of the actuation shaft 18. The aperture 68 is positioned so as to be coincident with the end of the internal channel opposite the container 12.

In the embodiment of FIGS. 1 to 7, the cosmetic product leaves the aperture 68 freely. This aperture 68 is in direct communication with the outside, without any nozzle or cosmetic product dispersion member being mounted in or on the outlet of the aperture 68.

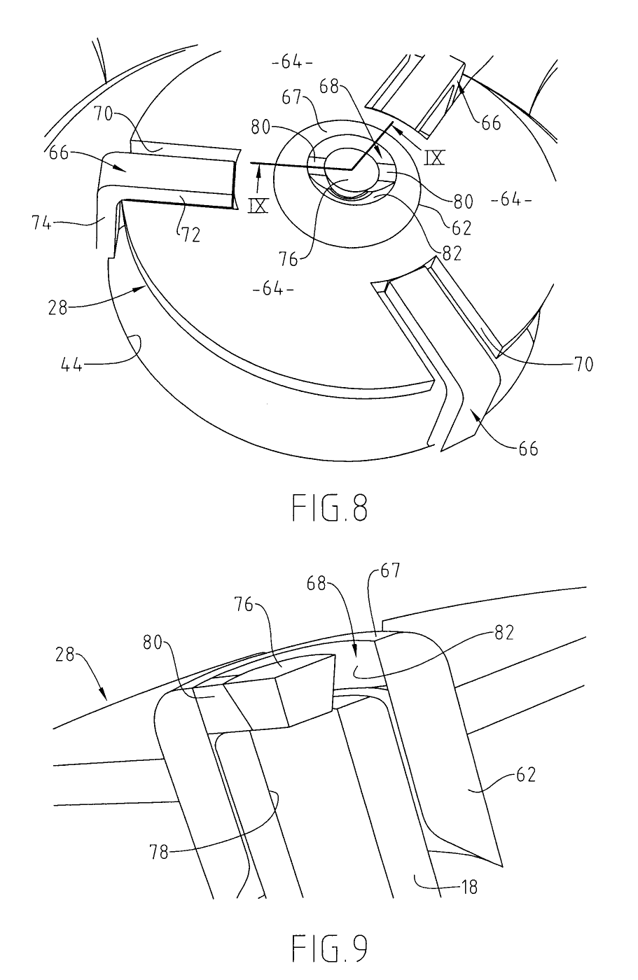

In the embodiment of FIGS. 8 and 9, by contrast, the massage and application device 16 comprises a discharging means 76 positioned in the aperture 68.

The aperture 68 is substantially frustum-shaped and the cross-section of the passage widens from the inside to the outside of the recess for receiving the shaft 18. The discharging means 76 is a solid, frustum-shaped part, positioned in the centre of the aperture 68, in the extension of the internal channel 78 of the actuation shaft. The cross-section of the discharging means widens from the inside towards the outside of the recess for receiving the shaft.

The discharging means 76 is integral with the peripheral edge of the aperture 68 via material webs 80.

The end of the discharging means 76 with a small cross-section has a cross-section smaller than the cross-section of the passage of the internal channel 78. The discharging means is positioned at a short distance along the longitudinal axis A from the free end of the shaft 18.

The cosmetic product expelled from the internal channel 78 of the actuation shaft impacts against the discharging means 76 and is deflected into the annular space 82 between the discharging means 76 and the peripheral edge of the aperture 68. In this way, the flow of cosmetic product is widened by comparison with the embodiment of FIGS. 1 to 7.

The movable support 28 typically comprises three sectors 64, in the form of an annular sector, regularly distributed about the cone 62. Each sector 64 supports two massage members 30. The sectors 64 define between them three radial gaps 70 for the material webs 66 to pass through. As viewed along the longitudinal axis A, the support 28 defines a recess which is inscribed in the central opening 44 of the band 32. In this way, it is possible to mould the movable support 28 in one mould without a movable slide.

The material webs 66 are L-shaped. Each web 66 comprises a radial arm 72 integral with the movable support 28, and an axial arm 74 integral with the band 32. Each radial arm 72 extends into one of the gaps 70. The arms 72 are integral with the annular region 65 connecting the sectors 64 to the cone 62.

The axial arms 74 of the material webs are integral with the annular wall 42, and more specifically with the peripheral edge of the opening 44.

The central massage members 30 are also substantially cylindrical or frustum-shaped projections. They point axially away from the container 12 from the movable support 28.

The central projections 30 may be of a single material, as shown in FIG. 2. They may also, like the peripheral projections, be of two materials and comprise a lower part of a first plastics material and a distal part of a different material which is more flexible than the first. Said different material may be of the same type as for the peripheral projections 30.

The massage and application device comprises for example six central massage members 30, arranged in a circle centred on the release aperture 68. The device comprises for example ten peripheral projections 26 arranged around the central projections 30 in a second circle centred on the release aperture 68. The second circle has a greater diameter than the first.

As stated above, the actuation shaft 18 of the dispensing member is movable along the longitudinal axis A between an inactive position, shown in FIG. 6, in which the cosmetic product does not pass through the internal through-channel, and an active position, in which the shaft allows the passage of cosmetic product through the internal through-channel. The actuation shaft 18 passes from the inactive to the active position thereof by displacement along the longitudinal axis A in the direction retracting into the interior of the container 12. In the active position, the cosmetic product passes through the internal through-channel under the effect of the internal pressure inside the container, or under the action of a pump, or under the effect of gravity, or under the pressure exerted by the user on the deformable wall of the container.

The central support 28 is suitable for actuating the dispensing member 14, in the sense that a pressure exerted on the movable support 28 is able to shift the dispensing member 14 from a state where the cosmetic product cannot exit the storage container, to another state in which the cosmetic product can exit the storage container. More specifically, the actuation shaft 18 can be displaced from the inactive to the active position thereof when a pressure is exerted on the movable support 28, towards the container 12.

The movable support 28 is normally in a stand-by position, shown in particular in FIGS. 2 and 5. In this stand-by position, the support 28 is axially offset away from the container 12 relative to the wall 42 of the band. The material webs 66 are thus in an L-shape, the arms 72 and 74 being mutually perpendicular.

From this stand-by position, the support 28 can be displaced axially relative to the fixed support 24 with the shaft 18, by retracting into the container 12. When the pressure on the movable support 28 is released, it returns to the stand-by position thereof under the effect of the resilience of the material webs 66. Likewise, the actuation shaft returns to the inactive position thereof under the action of return means (not shown). The mobile support 28 cannot normally be displaced rotationally with respect to the fixed support 24, especially around longitudinal axis A.

As can be seen in particular in FIG. 6, when the peripheral massage members are in the rest position thereof and when the movable central support is in the stand-by position thereof, the peripheral massage members project axially relative to the fixed support 24 at a greater height than the central massage members.

The operation of the massage and dispensing assembly described above will now be discussed in greater detail.

To use the massage and dispensing assembly 10, the user first removes the cap 22. He subsequently positions the assembly in such a way that the massage and application device 16 is oriented downwards, the massage members 26 being pressed against the scalp.

If he merely wishes to massage the scalp, the user presses the massage and dispensing assembly 10 onto the scalp with moderate pressure. This situation is shown in FIG. 6.

The user moderates his effort in such a way that the peripheral massage members 26 are not displaced or are only slightly displaced from the respective rest position thereof. The central massage members 30 are not normally in contact with the scalp.

The user displaces the massage and dispensing assembly laterally, i.e. in a plane substantially perpendicular to the longitudinal axis A.

When the user wishes to release the cosmetic product onto his scalp, he presses the massage and dispensing device onto the scalp more forcefully. The user moderates his effort in such a way as to displace the peripheral massage members 26 from the rest positions to the retracted positions thereof, as shown in FIG. 7.

Once the peripheral massage members are sufficiently displaced, the central massage members 30 come into contact with the scalp. If the user increases the pressure, the scalp starts to press the movable support 28 and the actuation shaft 18 towards the container, thus controlling the passage of the cosmetic product through the through-channel of the actuation shaft. The cosmetic product travels through the release aperture 68 and is released onto the user's scalp. When the user removes the massage and treatment assembly from the scalp, the actuation shaft and the movable support return to the starting positions thereof. Moreover, the peripheral massage members 26 return to the rest position thereof under the effect of the resilience of the tabs 46.

Thus, the rest position is a scalp massage position. The retracted position is a position for actuating the dispensing member 14. The peripheral massage members 26 are deformable from one position to another. It is thus understood that the tabs 46 supporting the massage members 26 are deformed. In one embodiment, it is the peripheral massage members 26 themselves which are deformed, not the tabs 46. In yet another variant, both the tabs 46 and the massage members 26 are deformed.

It should be noted that the massage and application device is completely integrally moulded. It can be produced in one mould without a movable slide.

If the peripheral and central massage members are of a single material, the massage and application device is obtained by injecting a single plastics material into the mould. This material may for example be polypropylene.

If the massage members are of two materials, the massage and application device can be obtained by injecting two different plastics materials into the mould. The first plastics material, which may be polypropylene, forms the band, the movable central support and part of the central and/or peripheral massage members.

The second plastics material, which is one of the plastics materials stated above, forms the distal part of the peripheral and/or central massage members.

The massage and cosmetic product dispensing assembly described above exhibits numerous advantages.

Because it comprises a support which is fixed relative to the container and which supports massage members, and a central support which is movable relative to the fixed support and is connected to the dispensing member, this central support supporting other massage members, it is easier to calibrate the force with which the massage and dispensing assembly must be applied to the scalp to trigger the application of the cosmetic product. When all the massage members are supported by a support member mounted on the actuation shaft of the dispensing device, the force to be applied to cause the cosmetic product to be applied necessarily corresponds to the resistance of the actuation shaft to retraction.

In the invention, the force to be applied is the force allowing the massage members supported by the movable central support to be brought into contact with the scalp and allowing the actuation shaft to be retracted. This force is therefore not merely connected to the resistance of the actuation shaft to retraction.

Moreover, the massage assembly is more tolerant of the application force of the massage members onto the scalp being out of alignment with the actuation shaft of the dispensing member or oblique relative to said shaft. An unaligned or oblique force will result in some peripheral massage members being applied more strongly to the scalp. Because these members are mounted on a support fixed to the container, the central support and the actuating shaft will not be greatly affected. This reduces the risk of damaging the actuation shaft or detaching the massage and application device from the dispensing member.

The massage and application device can be produced by injecting plastics material into one mould without movable slides. This is particularly cost-effective.

When the massage members comprise a distal part formed of a thermo-plastic elastomer which is slightly adhesive towards the scalp, the massage and application device may be used to move the scalp. These same massage members, after the release of the cosmetic product, may be used to massage the scalp, because the cosmetic product will cause the massage members to slide over the scalp.

The fact that the peripheral massage members project further than the central massage members relative to the fixed support is particularly advantageous. This makes it possible to adapt the shape of the massage and application device to the convex shape of the head. Moreover, it makes it possible to adjust the pressure required to trigger the release of cosmetic product onto the scalp.

The fact that the peripheral massage members have stops for cooperating with the fixed support collar makes it possible to delimit the path of the peripheral massage members and to prevent the deformable tabs, which provide the connection between the peripheral members and the collar, from being damaged by repeated excessive retractions.

The massage and dispensing assembly described above may have numerous variants.

The peripheral massage members may be fixed relative to the fixed support. In this case, it is necessary to set the height of the central massage members relative to the peripheral massage members carefully, so as to make it possible to actuate the cosmetic product dispensing member without the user having to apply excessive pressure.

The massage and application device may not comprise a material web connecting the movable central support to the fixed support. In this case, the central support is completely independent of the fixed support, and is supported merely by the dispensing member.

The cosmetic product release aperture formed in the movable central support may be replaced with a release nozzle, in such a way as to allow the dispensing of cosmetic product to be better controlled.

The massage and application device may comprise a pad made of a porous material, arranged between the central massage members. This pad is thus positioned opposite the cosmetic product release aperture. In this way, the propellant gas for the cosmetic product, coming from the container 12, cannot be released directly onto the user's scalp.

The sensation of coldness felt by the user when the gas is released directly onto the scalp is eliminated. Moreover, the pad forms a store of cosmetic product which makes it possible to apply the product less frequently. The pad is held in a reversible manner between the central massage members. It can thus be changed each time the cosmetic product is applied. The pad is held by means which are known per se and which will not be described in the present document.

Obviously, numerous modifications and variations of the present invention are possible in light of the above teachings. It is therefore to be understood that within the scope of the appended claims, the invention may be practiced otherwise than as specifically described therein.

1. A massage and cosmetic product dispensing assembly, comprising:
a cosmetic product storage container;
a member for dispensing the cosmetic product stored in the container; and
a massage and cosmetic product application device, wherein the massage and application device includes:
a fixed support which is fixed relative to the container;
peripheral massage members connected to the fixed support;
a central support which is movable relative to the fixed support and suitable for actuating the dispensing member; and
central massage members connected to the movable central support.

2. The massage and dispensing assembly according to claim 1,
wherein the massage and application device is molded in one piece.

3. The massage and dispensing assembly according to claim 1,
wherein one or more of the peripheral or central massage members include a lower part made of a first plastics material and a distal part made of a second plastics material different from the first, configured to come into contact with the user's scalp, and
wherein the second plastics material is more flexible than the first.

4. The massage and dispensing assembly according to claim 1,
wherein the movable support is connected to the fixed support via at least one deformable material web.

5. The massage assembly according to claim 1, wherein the peripheral massage members are deformable between at least one first massage position and at least one second actuation position of said dispensing member via said central support.

6. The massage and dispensing assembly according to claim 1,
wherein the peripheral massage members are deformable upon engagement with the region to be treated, and
wherein the region to be treated is the scalp.

7. The massage and dispensing assembly according to claim 1,
wherein the cosmetic product dispensing member includes an actuation shaft provided with an internal channel for the cosmetic product to pass through, the actuation shaft being movable between an inactive position, in which the cosmetic product does not pass through the through-channel, and an active position allowing the passage of the cosmetic product through the through-channel, the movable support being connected to the actuation shaft.

8. The massage and dispensing assembly according to claim 7,
wherein the movable support includes a central cone for receiving a distal end of the actuation shaft, said cone being provided with an aperture for releasing the cosmetic product, and being positioned in the extension of the through-channel of the actuation shaft.

9. The massage and dispensing assembly according to claim 1,
wherein the movable support includes an aperture for releasing the cosmetic product, and the central massage members are arranged in a first circle centred on the release aperture.

10. The massage and dispensing assembly according to claim 1,
wherein the movable support includes an aperture for releasing the cosmetic product, and the peripheral massage members are arranged around the central massage members in a second circle centred on the release aperture.

11. The massage and dispensing assembly according to claim 7,
wherein the central and peripheral massage members are projections extending substantially parallel to the actuation shaft.

12. The massage and dispensing assembly according to claim 7,
wherein the peripheral massage members are movable relative to the fixed support in each case between a rest position, in which said peripheral massage member projects at a first height relative to the fixed support parallel to the actuation shaft, and a retracted position, in which said peripheral massage member projects at a second height relative to the fixed support parallel to the actuation shaft, the second height being less than the first.

13. The massage and dispensing assembly according to claim 12,
wherein the peripheral massage members and the fixed support are shaped in such a way that at least one peripheral massage member abuts against the fixed support when said peripheral massage member reaches the retracted position thereof.

14. The massage and dispensing assembly according to claim 12,
wherein the peripheral massage members are connected to the fixed support via deformable tabs.

15. The massage and dispensing assembly according to claim 12,
wherein when the actuation shaft is in the inactive position thereof, the peripheral massage members project relative to the fixed support parallel to the actuation shaft at a greater height than the central massage members.

16. A massage and cosmetic product application device, the device comprising:
a fixed support for rigid connection to a container for storing the cosmetic product;
peripheral massage members connected to the fixed support;
a movable central support, for connection to a member for dispensing the cosmetic product stored in the container, and movable relative to the fixed support; and
central massage members connected to the movable central support.
